(19) United States
(12) Patent Application Publication
(10) Pub. No.: US 2021/0081827 A1
(43) Pub. Date: Mar. 18, 2021

(54) FAST CLUSTERING ALGORITHM BASED ON KERNEL FUZZY C-MEANS INTEGRATED WITH SPATIAL CONSTRAINTS

(71) Applicant: GUANGDONG UNIVERSITY OF TECHNOLOGY, GUANGZHOU (CN)

(72) Inventors: Jian GAO, Guangzhou (CN); Ruirong LUO, Guangzhou (CN); Lanyu ZHANG, Guangzhou (CN); Haixiang DENG, Guangzhou (CN); Xin CHEN, Guangzhou (CN)

(21) Appl. No.: 17/088,577

(22) Filed: Nov. 3, 2020

Related U.S. Application Data
(63) Continuation of application No. PCT/CN2019/095970, filed on Jul. 15, 2019.

(51) Int. Cl. G06N 5/04; G06K 9/62; G06T 5/00

(52) U.S. Cl. CPC G06N 5/048; G06T 5/009; G06K 9/6215; G06K 9/6273

(57) ABSTRACT

A fast clustering algorithm of kernel fuzzy C-means integrated with spatial constraints, including (1) applying the illumination processing algorithm, the preprocessed image affected by illumination is constructed; (2) After step (1), the original image and preprocessed image are mapped to the feature space using Gaussian kernel to cluster and segment. Providing a defect segmentation method for fluorescent glue which is robust to illumination to process and calculate the illuminated image, so as to complete the detection of foreign matters, bubbles and discoloration defects of fluorescent glue in lighting products. The disclosure provides a fast clustering algorithm of kernel fuzzy C-means integrated with spatial constraints. The image is mapped into the feature space, and the objective function of kernel fuzzy C-means clustering is optimized by using the spatial relationship of pixels, so that the clustering process has segmentation robustness to the gray value change of similar pixels caused by environmental changes.

### CROSS-REFERENCE TO RELATED APPLICATIONS

This application is a continuation of International Patent Application No. PCT/CN2019/095970 with a filing date of Jul. 15, 2019, designating the United States, now pending.

### TECHNICAL FIELD

The present disclosure relates to the technical field of algorithms, and more particularly relates to a fast clustering algorithm based on kernel fuzzy C-means integrated with spatial constraints.

### BACKGROUND

Kernel fuzzy C-means clustering is an unsupervised clustering method has been widely used in image segmentation in recent years, which can generate subsets of data sets. Among the existing clustering methods, Fuzzy C-means (FCM) proposed by Bezdek (1974) is one of the most active data, analysis methods in recent years, which is often used for image segmentation in image processing. However, the fuzzy C-means method only considers the gray information of the image and does not consider the spatial position of pixels. Therefore, FCM algorithm is particularly sensitive to noise and has a slow speed. Since then, there have been many methods to improve the performance and computational complexity of FCM algorithm. Shankar and Pal (1994) proposed a fast fuzzy C-means (FFCM) progressive data sampling method. In this method, the image is divided into several scalable partitions according to the pixel value. In the iterative algorithm, when the difference of the objective function between the partitions is lower than the threshold value, the algorithm stops. Ahmed et al. added neighborhood constraints to the objective function of FCM and proposed FCM_S algorithm, but FCM_S algorithm needs to calculate the color characteristics of the neighborhood in each iteration step, which is high time complexity. With the help of Markov random field (MRF), Feng et al. introduced neighborhood constraints into FCM algorithm, and proposed GFCM algorithm. By defuzzizing the fuzzy membership function value of pixels, a temporary segmentation field was obtained. Then, the local conditional probability of a certain pixel belonging to each kind of pixel was calculated by MRF theory. Finally, the local conditional probability was introduced into the objective function of FCM algorithm. Although there are many improved FCM algorithms, most of them focus on how to improve the purity of the class or the difference between the classes. For example, Liu & Miyamoto introduced the entropy function to the clustering process to make the pixels within the class more pure after image segmentation, providing improved methods such as secondary entropy and relative entropy. However, the cluster center and membership in the segmentation result is still not accurate enough for the image with great impact on the environment.

### SUMMARY

In order to overcome the defect of inaccurate segmentation in the prior art, the disclosure provides a fast clustering algorithm of kernel fuzzy C-means integrated with spatial constraints, the algorithm maps the image into the feature space, and optimizes the objective function of kernel fuzzy C-means clustering by using the spatial relationship of pixels, so that the clustering process has segmentation robustness to the change of gray values of similar pixels caused by environmental changes.

To solve the above technical problem, the technical solution adopted by the disclosure is as follows:

A fast clustering algorithm based on kernel fuzzy C-means integrated with spatial constraints is, provided, the fast clustering algorithm includes the steps as follows:

(1) constructing a preprocessed image affected by illumination by applying an illumination processing algorithm;

(2) mapping an original image and the preprocessed image to a feature space using Gaussian kernel, performing clustering and segmentation on the image after step (1).

Preferably, constructing a preprocessed image xᵣ affected by illumination in the step (1) includes the steps as follows,

(a) setting a convolution kernel of image (m*n), traversing the images;

(b) calculating an average value of pixels (Ave) and a pixel value (pix) in the convolution kernel after the step (a);

(c) repeating step (b) until traversing of the original image is completed, and a size of the preprocessed image is the same as that of the original image.

Preferably, if the average value of pixels (Ave) is greater than a preset threshold T in the step (b), then the pixel value (pix) is to be set as:

$$p i x = k \frac{1}{m n} {\sum }_{i = 1}^{m \times n} {N}_{i} - C \qquad ( 1 )$$

wherein k is a constant, in and n are convolution kernel size, Nᵢ are the pixel value of the i-th neighborhood pixel, and C is a constant value;

if the average value of pixels (Ave) is smaller than the preset threshold T, then the pixel value (pix) is to be set as:

$$p i x = N - \frac{1}{m n} {\sum }_{i = 1}^{m \times n} {N}_{i} \qquad ( 2 )$$

wherein N is an original value of the pixel, and Nᵢ is the pixel value of the i-th neighborhood pixel.

Preferably, an compensation terms of the objective function including spatial relation in the feature space in the step (2) are as follows:

$${\sum }_{i = 1}^{c} {a}_{i}^{*} {\sum }_{k = 1 , {x}_{r} {eN}_{i}}^{N} {u}_{ik}^{m} {‖ φ ( {x}_{r} ) - φ ( {v}_{i} ) ‖}^{2} ;$$

wherein, xᵣ is the spatial relation information map considering an influence of illumination;

aᵢ=min∥xₖ−vᵢ∥²*a is a dynamic convergence factor used to accelerate a convergence speed of the algorithm, wherein a is constant;

aᵢ is based on the minimum Euclidean distance of pixels, if the Euclidean distance is small, that is, the pixels are close to the cluster center, and the clustering is close to convergence, an impact of aᵢ on the objective function is small, and the change degree of the objective function value becomes smaller; if the distance between the pixels and the cluster center is large, the value of aᵢ is larger, which makes a step size of the objective function change towards the convergence direction larger, and accelerates the convergence speed of the algorithm.

Preferably, an optimal objective function formula is as follows:

$$\begin{matrix}\begin{matrix}min J ( U , V ) = {\sum }_{i = 1}^{c} {\sum }_{k = 1}^{N} {u}_{ik}^{m} {‖ φ ( {x}_{k} ) - φ ( {v}_{i} ) ‖}^{2} + \\ {\sum }_{i = 1}^{c} {a}_{i}^{*} {\sum }_{k = 1 , x , {eN}_{i}}^{N} {u}_{ik}^{m} {‖ φ ( {x}_{r} ) - φ ( {v}_{i} ) ‖}^{2} ; \\ = {\sum }_{i = 1}^{c} {\sum }_{k = 1}^{N} {u}_{ik}^{m} ( 2 - 2 K ( {v}_{i} , {v}_{k} ) ) + \\ {\sum }_{i = 1}^{c} {a}_{i} * {\sum }_{k = 1 , x , {eN}_{i}}^{N} {u}_{k}^{m} ( 2 - 2 K ( {v}_{i} , {v}_{r} ) )\end{matrix} & ( 3 ) \\ K ( v , x ) = {e}^{- \frac{{‖ k - x ‖}^{2}}{2 {σ}^{2}} ;} & ( 4 ) \\ st . {\sum }_{i = 1}^{c} {u}_{ik} = 1 , i ∈ [ 1 , c ] , k ∈ [ 1 , N ] , {u}_{ik} > 0 & \end{matrix}$$

wherein, aᵢ=min∥xₖ−vᵢ∥²*a, wherein a is constant; xᵣ is the preprocessed image; xₖ is the original image, c is the number of clustering, N is the number of pixels in, the image; μᵢₖ is tile membership degree of the k-th pixel xₖ on the image to the cluster center vₖ of class i; the exponent m is the fuzzy exponent, usually taken as m=2; ϕ(x) represents the mapping of pixel values to Gaussian feature space, which can be expressed by Gaussian radial basis function K(v, x); K(v, x) represents the Gaussian radial basis function, that is, the kernel function used by the algorithm, where u is width parameter of the function which controls the radial range of the function;

combined with Lagrange multiplier method, a derivation of the objective function is carried out, and the expressions of membership degree and cluster center are obtained as follows:

$$\begin{matrix}{u}_{ik} = \frac{{( 1 - K ( {v}_{i} , {x}_{k} ) - {a}_{i} {\sum }_{i = 1}^{c} ( 1 - K ( {v}_{i} , {x}_{r} ) ) )}^{\frac{1}{m - 1}}}{{\sum }_{i = 1}^{c} {( 1 - K ( {v}_{i} , {x}_{k} ) - {a}_{i} {\sum }_{i = 1}^{c} ( 1 - K ( {v}_{i} , {x}_{r} ) ) )}^{\frac{1}{m - 1}}} & ( 5 ) \\ {v}_{i} = \frac{{\sum }_{k = 1}^{N} {u}_{ik}^{m} K ( {v}_{i} , {x}_{k} ) {x}_{k} - {a}_{i} {\sum }_{i = 1}^{c} {\sum }_{r = 1}^{N} {u}_{ir}^{m} K ( {v}_{i} , {x}_{r} ) {v}_{i}}{{\sum }_{k = 1}^{N} {u}_{ik}^{m} K ( {v}_{i} , {v}_{k} ) - {a}_{i} {\sum }_{i = 1}^{c} {\sum }_{r = 1}^{N} {u}_{ir}^{m} K ( {v}_{i} , {x}_{r} )} & ( 6 )\end{matrix}$$

the meanings of parameters in formula (5) and formula (6) are consistent with those in formula (3) and formula (4), and the same below.

Preferably performing clustering and segmentation on the image in the step (2), includes steps as follows:

step 201, determining the number of clusters c (no more than √N, N: the total number of pixels in the image), fuzzy index m, iteration stop error E, and maximum iteration number T;

step 202, initializing the cluster center v (random or preset value) of the original space;

step 203, calculating the initial value of the distance matrix D by formula ∥ϕ(xᵢ)−ϕ(vᵢ)∥, wherein ϕ(vᵢ) is the cluster center of the feature space, and ϕ(xᵢ) is the i-th pixel in the feature space;

step 204, updating the cluster center according to cluster center formula:

$${v}_{i} = \frac{{{\sum }^{N}}_{k = 1} {u}_{ik}^{m} K ( {v}_{i} , {x}_{k} ) {x}_{k} - {a}_{i} {{\sum }_{i = 1}}^{c} {{\sum }_{r = 1}}^{N} {u}_{ir}^{m} K ( {v}_{i} , {x}_{r} ) {v}_{i}}{{{\sum }^{N}}_{k = 1} {u}_{ik}^{m} K ( {v}_{i} , {x}_{k} ) - {a}_{i} {{\sum }_{i = 1}}^{c} {{\sum }^{N}}_{r = 1} {u}_{ir}^{m} K ( {v}_{i} , {x}_{r} )} \qquad ( 7 )$$

step 205, updating the membership degree according to the membership degree formula:

$${u}_{ik} = \frac{{( 1 - K ( {v}_{i} {x}_{k} ) - {a}_{i} {{\sum }_{i = 1}}^{c} ( 1 - K ( {v}_{i} , {x}_{r} ) ) )}^{- \frac{1}{m - 1}}}{{\sum }_{{ }^{i = 1}}^{c} {( 1 - K ( {v}_{i} , {x}_{k} ) - {a}_{i} {\sum }_{i = 1}^{c} ( 1 - K ( {v}_{i} , {x}_{r} ) ) )}^{- \frac{1}{m - 1}}} \qquad ( 8 )$$

step 206, recalculating the distance matrix D, and calculating the value of the objective function according to the obtained cluster center and membership degree;

$$J ( U , V ) = {\sum }_{i = 1}^{c} {\sum }_{k = 1}^{N} {u}_{ik}^{m} ( 2 - 2 K ( {v}_{i} , {x}_{k} ) ) + {\sum }_{i = 1}^{c} {a}_{i}^{*} {{\sum }_{k = 1 , {x}_{r} ∈ {N}_{k}}}^{N} {u}_{ik}^{m} ( 2 - 2 K ( {v}_{i} , {x}_{r} ) ) \qquad ( 9 )$$

step 207, stopping the iteration process, if the number of iterations is greater than the maximum number of iterations T or the difference between the before and after of the objective function is less than the iteration stop error or the difference between the before and after the membership matrix is less than the preset iteration stop error; otherwise, returning to step 204;

step 208, dividing the pixels into the class with the largest membership degree according to the membership matrix.

Compared with the prior art, the present disclosure has the following advantageous effects:

The disclosure provides a fast clustering algorithm of kernel fuzzy C-means integrated with spatial constraints, which has certain robustness to illumination changes to perform image segmentation. The algorithm can make the clustering algorithm have certain robustness to the influence of the environment illumination on the image. Before clustering, the image of the relevant neighborhood information is calculated first, and the influence of the minimum Euclidean distance is considered in the iteration process, to accelerate the convergence process of pixels to the cluster center and complete image segmentation.

### BRIEF DESCRIPTION OF THE DRAWINGS

FIG. 1 is the flow chart of a fast clustering algorithm based on kernel fuzzy C-means integrated with spatial constraints.

### DETAILED DESCRIPTION OF THE EMBODIMENTS

The present disclosure will be further described in combination with specific embodiments. Wherein, the attached drawings are only for illustrative purposes, and represent only schematic drawings rather than physical drawings, which cannot be understood as restrictions on the present patent. In order to better illustrate the embodiments of the present disclosure, some parts of the drawings may be omitted, enlarged or reduced, which does not represent the size of the actual product. For those skilled in the art, they can understand that some well-known structures and their descriptions may be omitted.

In the drawings of the embodiment of the present disclosure, the same or similar labels correspond to the same or similar components; in the description of the disclosure, it should be understood that if the terms “up”, “down”, “left” and “right” indicate the orientation or position relationship based on the position or position relationship shown in the drawings, it is only for the convenience of describing the disclosure and simplifying the description, rather than indicating or implying the device or element labeled must have a specific orientation, or be constructed and operated in a specific orientation. Therefore, the terms describing the position relationship in the drawings are only used for illustration and cannot be understood as a limitation of the present patent. For those skilled in the art, the specific meanings of the above terms can be understood according to the specific circumstances.

### Embodiment

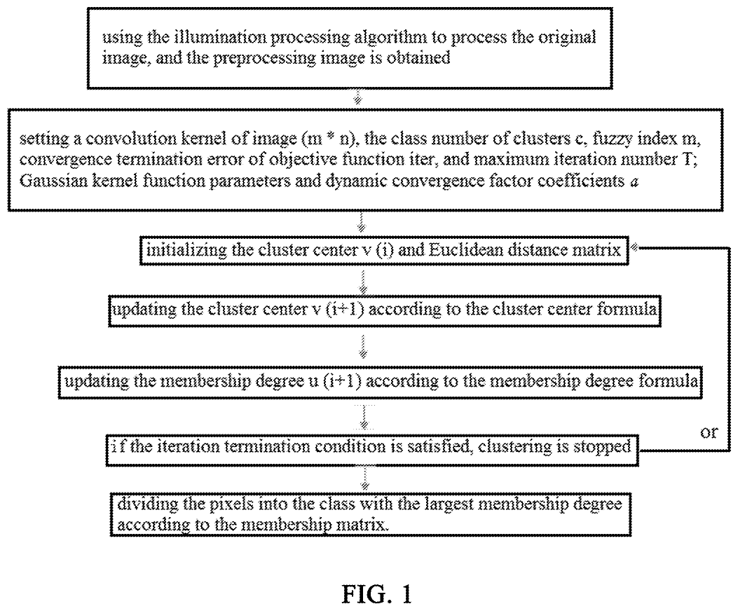

As shown in FIG. 1, a fast clustering algorithm based on kernel fuzzy C-means integrated with spatial constraints is provided by the present disclosure, the fast clustering algorithm includes the steps as follows:

(1) A preprocessed image affected by illumination is constructed by applying an illumination processing algorithm;

(2) An original image and the preprocessed image are mapped to a feature space using Gaussian kernel to perform clustering and segmentation on the image after step (1).

Wherein, the step of constructing a preprocessed image xᵣ affected by illumination in the step (1) includes the steps as follows:

(a) A convolution kernel of image (m*n) is set, the images are traversed;

(b) An average value of pixels (Ave) and a pixel value (pix) in the convolution kernel are calculated after the step (a);

(c) repeating step (b) until traversing of the original image is completed, and a size of the preprocessed image is the same as that of the original image.

Besides, if the average value of pixels (Ave) is greater than a preset threshold T in the step (b), then the pixel value (pix) is to be set as:

$$p i x = k \frac{1}{m n} {\sum }_{i = 1}^{m \times n} {N}_{i} - C \qquad ( 1 )$$

Wherein, k is a constant, m and n are convolution kernel size, Nᵢ are the pixel value of the i-th neighborhood pixel, and C is a constant value.

If the average value of pixels (Ave) is smaller than the preset threshold T, then the pixel value (pix) is to be set as:

$$p i x = N - \frac{1}{m n} {\sum }_{i = 1}^{m \times n} {N}_{i} \qquad ( 2 )$$

Wherein, N is an original value of the pixel, and Nᵢ is the pixel value of the i-th neighborhood pixel.

Wherein an compensation terms of the objective function including spatial relation in the feature space in the step (2) are as follows:

$${\sum }_{i = 1}^{c} {a}_{i} * {\sum }_{k = 1 , {x}_{r} ∈ {N}_{k}}^{N} {u}_{ik}^{m} {‖ φ ( {x}_{r} ) - φ ( {v}_{i} ) ‖}^{2} ;$$

wherein, xᵣ is the spatial relation information map considering an influence of illumination;

aᵢ=min∥xₖ−vᵢ∥²*a is a dynamic convergence factor used to accelerate a convergence speed of the algorithm, wherein a is constant.

aᵢ is based on the minimum Euclidean distance of pixels, if the Euclidean distance is small, that is, the pixels are close to the cluster center, and the clustering is close to convergence, an impact of aᵢ on the objective function is small, and the change degree of the objective function value becomes smaller; if the distance between the pixels and the cluster center is large, the value of aᵢ is larger, which makes a step size of, the objective function change towards the convergence direction larger, and accelerates the convergence speed of the algorithm.

Besides, an optimal objective function formula is as follows:

$$\begin{matrix}min J ( U , V ) = {\sum }_{i = 1}^{c} {\sum }_{k = 1}^{N} {u}_{ik}^{m} {‖ φ ( {x}_{k} ) - φ ( {v}_{i} ) ‖}^{2} + \\ {\sum }_{i = 1}^{c} {a}_{i}^{*} \text{?} {u}_{ik}^{m} {‖ φ ( {x}_{r} ) - φ ( {v}_{i} ) ‖}^{2} ; \\ = {\sum }_{i = 1}^{c} {\sum }_{k = 1}^{N} {u}_{ik}^{m} ( 2 - 2 K ( {v}_{i} , {x}_{k} ) ) + \\ {\sum }_{i = 1}^{c} {a}_{i}^{*} \text{?} {u}_{k}^{m} ( 2 - 2 K ( {v}_{i} , {x}_{r} ) )\end{matrix} \\ \text{?} \text{indicates text missing or illegible when filed} \qquad ( 3 )$$

wherein, aᵢ=min∥xₖ−vᵢ∥²*a, wherein a is, constant; xᵣ is the preprocessed image;

$$K ( v , x ) = e \text{?} ; \\ st . {\sum }_{i = 1}^{c} {u}_{ik} = 1 , i ∈ [ 1 , c ] , k ∈ [ 1 , N ] , {u}_{k} > 0 \\ \text{?} \text{indicates text missing or illegible when filed} \qquad ( 4 )$$

xₖ is the original image, c is the number of clustering, N is the number of pixels in the image; μᵢₖ is the membership degree of the k-th pixel xₖ on the image to the cluster center vₖ of class i; the exponent m is the fuzzy exponent, usually taken as m=2; ϕ(x) represents the mapping of pixel values to the Gaussian feature space, which can be expressed by Gaussian radial basis function K(v, x); K(v, x) represents the Gaussian radial basis function, that is, the kernel function used by the algorithm, where σ is width parameter of the function, which controls the radial range of the function.

Combined with Lagrange multiplier method, a derivation of the objective function is carried out, and the expressions of membership degree and cluster center are obtained as follows:

$$\begin{matrix}{u}_{i k} = \frac{{( 1 - K ( {v}_{i} , {x}_{k} ) - {a}_{i} {\sum }_{i = 1}^{c} ( 1 - K ( {v}_{i} , {x}_{r} ) ) )}^{- \frac{1}{m - 1}}}{{\sum }_{i = 1}^{c} {( 1 - K ( {v}_{i} , {x}_{k} ) - {a}_{i} {\sum }_{i = 1}^{c} ( 1 - K ( {v}_{i} , {x}_{r} ) ) )}^{- \frac{1}{m - 1}}} & ( 5 ) \\ {v}_{i} = \frac{{\sum }_{k = 1}^{N} {u}_{ik}^{m} K ( {v}_{i} , {x}_{k} ) {x}_{k} - {a}_{i} {\sum }_{i = 1}^{c} {\sum }_{r = 1}^{N} {u}_{ir}^{m} K ( {v}_{i} , {x}_{r} ) {v}_{i}}{{\sum }_{k = 1}^{N} {u}_{ik}^{m} K ( {v}_{i} , {x}_{k} ) - {a}_{i} {\sum }_{i = 1}^{c} {\sum }_{r = 1}^{N} {u}_{ir}^{m} K ( {v}_{i} , {x}_{r} )} & ( 6 )\end{matrix}$$

Wherein, performing clustering and segmentation on the image in the step (2), includes steps as follows:

Step 201, determining the number of clusters c (no more than \sqrt{N}, N: the total number of pixels in the image), fuzzy index m, iteration stop error E, and maximum iteration number T;

Step 202, initializing the cluster center v (random or preset value) of the original space;

Step 203, calculating the initial value of the distance matrix D by, formula ∥ϕ(xᵢ)−ϕ(vᵢ)∥, wherein ϕ(vᵢ) is the cluster center of the feature space, and ϕ(xᵢ) is the i-th pixel in the feature space;

Step 204, updating the cluster center according to the cluster center formula:

$${v}_{i} = \frac{{\sum }_{k = 1}^{N} {u}_{ik}^{m} K ( {v}_{i} , {x}_{k} ) {x}_{k} - {a}_{i} {\sum }_{i = 1}^{c} {\sum }_{r = 1}^{N} {u}_{ir}^{m} K ( {v}_{i} , {x}_{r} ) {v}_{i}}{{\sum }_{k = 1}^{N} {u}_{ik}^{m} K ( {v}_{i} , {x}_{k} ) - {a}_{i} {\sum }_{i = 1}^{c} {\sum }_{r = 1}^{N} {u}_{ir}^{m} K ( {v}_{i} , {x}_{r} )} \qquad ( 7 )$$

Step 205, updating the membership degree according to the membership degree formula:

$${u}_{i k} = \frac{{( 1 - K ( {v}_{i} , {x}_{k} ) - {a}_{i} {\sum }_{i = 1}^{c} ( 1 - K ( {v}_{i} , {x}_{r} ) ) )}^{- \frac{1}{m - 1}}}{{\sum }_{i = 1}^{c} {( 1 - K ( {v}_{i} , {x}_{k} ) - {a}_{i} {\sum }_{i = 1}^{c} ( 1 - K ( {v}_{i} , {x}_{r} ) ) )}^{- \frac{1}{m - 1}}} \qquad ( 8 )$$

Step 206, recalculating the distance matrix D, and calculating the value of the objective function according to the obtained cluster center and membership degree;

$$J ( U , V ) = {{\sum }_{i = 1}}^{c} {\sum }_{k = 1}^{N} {u}_{ik}^{m} ( 2 - 2 K ( {v}_{i} , {x}_{k} ) ) + {\sum }_{i = 1}^{c} {a}_{i} * {\sum }_{k = 1 , {x}_{r} ∈ {N}_{k}}^{N} {u}_{ik}^{m} ( 2 - 2 K ( {v}_{i} , {x}_{r} ) ) \qquad ( 9 )$$

Step 207, stopping the iteration process, if the number of iterations is greater than the maximum number of iterations T or the difference between the before and after of the objective function is less than the iteration stop error or the difference between the before and after the membership matrix is less than the preset iteration stop error; otherwise, returning to step 204;

Step 208, dividing the pixels into the class with the largest membership degree according to the membership matrix.

Apparently, the above-mentioned embodiment of the present disclosure is only examples to illustrate the present disclosure clearly, rather than a limitation on the embodiment of the present disclosure. On the basis of the above description, other different forms of modifications or changes may be made for ordinary skilled person in the art. It is not necessary and impossible to enumerate all the embodiments here. Any modification, equivalent substitution and improvement made within the spirit and principle of the present disclosure shall be included in the scope of the claims of the present disclosure.

What is claimed is:

1. A fast clustering algorithm based on kernel fuzzy C-means integrated with spatial constraints, comprising
(1) constructing a preprocessed image affected by illumination by applying an illumination processing algorithm;
(2) mapping an original image and the preprocessed image to a feature space using Gaussian kernel, performing clustering and segmentation on the image after step (1).

2. The fast clustering algorithm based on kernel fuzzy C-means integrated with spatial constraints according to claim 1, wherein constructing a preprocessed image affected by illumination in the step (1) comprises steps as follows:
(a) setting a convolution kernel of image (m*n), traversing the images;
(b) calculating an average value of pixels (Ave) and a pixel value (pix) in the convolution kernel after the step (a);
(c) repeating step (b) until traversing of the original image is completed, and a size of the preprocessed image is the same as that of the original image.

3. The fast clustering algorithm based on kernel fuzzy C-means integrated with spatial constraints according to claim 2, wherein if the average value of pixels (Ave) is greater than a preset threshold T in the step (b), then the pixel value (pix) is to be set as:
$$pix = k \frac{1}{m n} {\sum }_{i = 1}^{m \times n} {N}_{i} - C \qquad ( 1 )$$
wherein k is a constant, m and n are convolution kernel size, Nᵢ are the pixel value of the i-th neighborhood pixel, and C is a constant value;
if the average value of pixels (Ave) is smaller than the preset threshold T, then the pixel value (pix) is to be set as:
$$p i x = N - \frac{1}{m n} {\sum }_{i = 1}^{m \times n} {N}_{i} \qquad ( 2 )$$
wherein N is an original value of the pixel, and Nᵢ is the pixel value of the i-th neighborhood pixel.

4. The fast clustering algorithm based on kernel fuzzy C-means integrated with spatial, constraints according to claim 1, wherein an compensation terms of the objective function comprising spatial relation in the feature space in the step (2) are as follows:
$${\sum }_{i = 1}^{c} {a}_{i} * {\sum }_{k = 1 , {x}_{r} ∈ {N}_{k}}^{N} {u}_{ik}^{m} {‖ φ ( {x}_{r} ) - φ ( {v}_{i} ) ‖}^{2} ;$$
wherein, xᵣ is the spatial relation information map considering an influence of illumination;
aᵢ=min∥xₖ−vᵢ∥²*a is a dynamic convergence factor used to accelerate a convergence speed of the algorithm, wherein a is constant;
aᵢ is based on the minimum Euclidean distance of pixels, if the Euclidean distance is small, that is, the pixels are close to the cluster center, and the clustering is close to convergence, an impact of aᵢ on the objective function is small, and the change degree of the objective function value becomes smaller; if the distance between the pixels and the cluster center is large, the value of aᵢ is larger, which makes a step size of the objective function change towards the convergence direction larger, and accelerates the convergence speed of the algorithm.

5. The fast clustering algorithm based on kernel fuzzy C-means integrated with spatial constraints according to claim 4, wherein an optimal objective function formula is as follows:
$$\begin{matrix}\begin{matrix}min J ( U , V ) = {\sum }_{i = 1}^{c} {\sum }_{k = 1}^{N} {u}_{ik}^{m} {‖ φ ( {x}_{k} ) - φ ( {v}_{i} ) ‖}^{2} + \\ {\sum }_{i = 1}^{c} {a}_{i}^{*} \text{?} {u}_{ik}^{m} {‖ φ ( {x}_{r} ) - φ ( {v}_{i} ) ‖}^{2} ; \\ = {\sum }_{i = 1}^{c} {\sum }_{k = 1}^{N} {u}_{ik}^{m} ( 2 - 2 K ( {v}_{i} , {x}_{k} ) ) + \\ {\sum }_{i = 1}^{c} {a}_{i}^{*} \text{?} {u}_{k}^{m} ( 2 - 2 K ( {v}_{i} , {x}_{r} ) )\end{matrix} & ( 3 ) \\ K ( v , x ) = e \text{?} ; \\ st . {\sum }_{i = 1}^{c} {u}_{ik} = 1 , i ∈ [ 1 , c ] , k ∈ [ 1 , N ] , {u}_{k} > 0 \\ \text{?} \text{indicates text missing or illegible when filed} & ( 4 )\end{matrix}$$
wherein, aᵢ=min∥xₖ−vᵢ∥²*a, wherein a is constant; xᵣ is the preprocessed image; xₖ is the original image, c is the number of clustering, N is the number of pixels in the image; μᵢₖ is the membership degree of the k-th pixel xₖ on the image to the cluster center vₖ of class the exponent m is the fuzzy exponent, usually taken as m=2; ϕ(x) represents the mapping of pixel values to the Gaussian feature space, expressed by Gaussian radial basis function K(v, x); K(v, x) represents the Gaussian radial basis function, that is, the kernel function used by the algorithm, wherein a is width parameter of the function, which controls the radial range of the function;
combined with Lagrange multiplier method, a derivation of the objective function is carried out, and the expressions of membership degree and cluster center are obtained as follows:
$$\begin{matrix}{u}_{i k} = \frac{{( 1 - K ( {v}_{i} , {x}_{k} ) - {a}_{i} {\sum }_{i = 1}^{c} ( 1 - K ( {v}_{i} , {x}_{r} ) ) )}^{- \frac{1}{m - 1}}}{{\sum }_{i = 1}^{c} {( 1 - K ( {v}_{i} , {x}_{k} ) - {a}_{i} {\sum }_{i = 1}^{c} ( 1 - K ( {v}_{i} , {x}_{r} ) ) )}^{- \frac{1}{m - 1}}} & ( 5 ) \\ {v}_{i} = \frac{{\sum }_{k = 1}^{N} {u}_{ik}^{m} K ( {v}_{i} , {x}_{k} ) {x}_{k} - {a}_{i} {\sum }_{i = 1}^{c} {\sum }_{r = 1}^{N} {u}_{ir}^{m} K ( {v}_{i} , {x}_{r} ) {v}_{i}}{{\sum }_{k = 1}^{N} {u}_{ik}^{m} K ( {v}_{i} , {x}_{k} ) - {a}_{i} {\sum }_{i = 1}^{c} {\sum }_{r = 1}^{N} {u}_{ir}^{m} K ( {v}_{i} , {x}_{r} )} & ( 6 )\end{matrix}$$
the meanings of parameters in formula (5) and formula (6) are consistent with those in formula (3) and formula (4), and the same below.

6. The fast clustering algorithm based on kernel fuzzy C-means integrated with spatial constraints according to claim 5, wherein performing clustering and segmentation on the image in the step (2), comprises steps as follows:
step 201, determining the class number of clusters c (no more than \sqrt{N}, N: the total number of pixels in the image), fuzzy index in, iteration stop error E, and maximum iteration number T;
step 202, initializing the cluster center v (random or preset value) of the original space;
step 203, calculating the initial value of the distance matrix D by formula ∥ϕ(xᵢ)−ϕ(vᵢ)∥, wherein ϕ(vᵢ) is the cluster center of the feature space, and ϕ(xᵢ) is the i-th pixel in the feature space;
step 204, updating the cluster center according to the cluster center formula:
$${v}_{i} = \frac{{\sum }_{k = 1}^{N} {u}_{ik}^{m} K ( {v}_{i} , {x}_{k} ) {x}_{k} - {a}_{i} {\sum }_{i = 1}^{c} {\sum }_{r = 1}^{N} {u}_{ir}^{m} K ( {v}_{i} , {x}_{r} ) {v}_{i}}{{\sum }_{k = 1}^{N} {u}_{ik}^{m} K ( {v}_{i} , {x}_{k} ) - {a}_{i} {\sum }_{i = 1}^{c} {\sum }_{r = 1}^{N} {u}_{ir}^{m} K ( {v}_{i} , {x}_{r} )} \qquad ( 7 )$$
step 205, updating the membership degree according to the membership degree formula:
$${u}_{i k} = \frac{{( 1 - K ( {v}_{i} , {x}_{k} ) - {a}_{i} {\sum }_{i = 1}^{c} ( 1 - K ( {v}_{i} , {x}_{r} ) ) )}^{- \frac{1}{m - 1}}}{{\sum }_{i = 1}^{c} {( 1 - K ( {v}_{i} , {x}_{k} ) - {a}_{i} {\sum }_{i = 1}^{c} ( 1 - K ( {v}_{i} , {x}_{r} ) ) )}^{- \frac{1}{m - 1}}} \qquad ( 8 )$$
step 206, recalculating the distance matrix D, and calculating the value of the objective function according to the obtained cluster center and membership degree;
$$J ( U , V ) = {{\sum }_{i = 1}}^{c} {\sum }_{k = 1}^{N} {u}_{ik}^{m} ( 2 - 2 K ( {v}_{i} , {x}_{k} ) ) + {\sum }_{i = 1}^{c} {a}_{i} * {\sum }_{k = 1 , {x}_{r} ∈ {N}_{k}}^{N} {u}_{ik}^{m} ( 2 - 2 K ( {v}_{i} , {x}_{r} ) ) \qquad ( 9 )$$
step 207, stopping the iteration process, the number of iterations is greater than the maximum number of iterations T or the difference between the before and after of the objective function is less than the iteration stop error or the difference between the before and after the membership matrix is less than the preset iteration stop error; otherwise, returning to step 204;
step 208, dividing the pixels into the class with the largest membership degree according to the membership matrix.
